(19) United States
(12) Patent Application Publication
(10) Pub. No.: US 2005/0202788 A1
(43) Pub. Date: Sep. 15, 2005

(54) Portable radio receiver unit

(76) Inventors: Joseph W. Vinson, Flowery Branch, GA (US); Kenneth A. Pirkle, Easley, SC (US); J. Bentley Parker, Gainesville, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/070,620

(22) Filed: Mar. 2, 2005

Related U.S. Application Data
(60) Provisional application No. 60/550,198, filed on Mar. 3, 2004.

(51) Int. Cl. H04B 1/38; H04B 1/08; H04Q 7/20

(52) U.S. Cl. 455/90.3; 455/575.1; 455/347

(57) ABSTRACT

Embodiments of the present disclosure provide systems and methods for receiving radio communications. Briefly described, in architecture, one embodiment of the system, among others, can be implemented as follows. A portable radio receiver unit is provided with a housing having interface controls and means connected to the housing for receiving radio communications by radio transmissions over radio frequencies. The portable radio receiver unit is capable of receiving radio communications over a frequency range including 450-470 MHz, and operation of the portable radio receiver unit is controlled solely by operation of four interface controls disposed in the housing. Other systems and methods are also provided.

### CROSS-REFERENCE TO RELATED APPLICATION

This application claims priority to copending U.S. provisional application entitled, “Portable Radio Receiver Unit,” having Ser. No. 60/550,198, filed Mar. 3, 2004, which is entirely incorporated herein by reference.

### TECHNICAL FIELD

The present disclosure is generally related to radio communications and, more particularly, is related to portable radio communications.

### BACKGROUND

A radio scanner is basically a radio receiver capable of receiving multiple radio signals in multiple frequency bands, e.g., UHF and VHF range. Present day use of radio scanners is extremely widespread in the United States of America and scanning is used for many purposes including information gathering, private hobbying, volunteer alerting, news gathering, etc. Radio scanners are used to follow law enforcement activities, fire fighters, emergency and rescue squads, highways, forestry, aircraft, railroads, utilities, business, transportation, schools, sports, theme parks, governments (federal, state, county, local), military and other non AM/FM radio communications.

For instance, with the huge popularity of motor sports racing, many people now use scanners at auto racing events to eavesdrop on the crew-driver communications at races. At a typical race, there are hundreds of frequencies in use. Each team has two or three frequencies, while race control, the sanctioning organization, the medical, fire and track crews and many others each have assigned frequencies during the race.

However, people often find the use of conventional scanners in motor sports events or other events to be cumbersome, since conventional scanners are quite bulky to carry in and of itself. Moreover, conventional scanners are problematic to carry, when an event participant may also be carrying a camera, event information material, cell-phone, concessions, etc. Further, conventional scanners may also be hard to operate if an event participant is carrying the aforementioned items, among others. For example, conventional scanners typically feature a numeric keypad that is generally used for entering frequencies or used for entering upper and lower ranges of a search between two frequencies, which generally requires the use of two hands to operate a radio scanner of this type. Such scanners typically weigh 1-2 pounds (including batteries) and are powered by multiple (usually 4) AA batteries or rechargeable batteries that require recharging via access to a fixed power supply.

Thus, a heretofore unaddressed need exists in the industry to address the aforementioned deficiencies and inadequacies.

### SUMMARY

Embodiments of the present disclosure provide systems and methods for receiving radio communications. Briefly described, in architecture, one embodiment of the system, among others, can be implemented as follows. A portable radio receiver unit is provided with a housing having interface controls and means connected to the housing for receiving radio communications by radio transmissions over radio frequencies. The portable radio receiver unit is capable of receiving radio communications over a frequency range including 450-470 MHz, and operation of the portable radio receiver unit is controlled solely by operation of four interface controls disposed in the housing.

In another embodiment, a portable radio receiver unit is provided with a housing having interface controls and means connected to the housing for receiving radio communications by radio transmissions over radio frequencies. The portable radio receiver unit is capable of receiving radio communications over a frequency range including 450-470 MHz and automatically scanning for radio communications over a subset of frequencies in the frequency range. Further, operation of the portable radio receiver unit is controlled solely by operation of six interface controls disposed in the housing.

Embodiments of the present disclosure can also be viewed as providing methods for receiving radio communications. In this regard, one embodiment of such a method, among others, can be broadly summarized by the following steps: shifting a portable radio receiver unit from a first condition where the portable radio receiver unit does not receive radio communications to a second condition where the portable radio receiver unit receives radio communications over a plurality of radio frequencies over a frequency range including 450-470 MHz; and selecting one of the plurality of radio frequencies for receiving radio communications via the portable radio receiver unit, where operation of the portable radio receiver unit is solely controlled by interface controls that lack a keyboard control. For example, in one embodiment, the interface controls consist of four individual interface controls.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a diagram representing one embodiment, among others, of a portable radio receiver unit of the present disclosure.

FIG. 2 is a block diagram of one embodiment, among others, of an electronics package of the portable radio receiver unit of FIG. 1.

FIGS. 3A-3B are block diagram representations of electronic components utilized in implementing the electronics package of FIG. 2.

FIGS. 4A-4B are circuit diagrams of one implementation, among others, of the electronics package of FIG. 2.

FIGS. 5A-5B are table diagrams listing circuit components for the circuit diagrams of FIGS. 3A-3B respectively.

FIG. 6 is a flowchart describing one embodiment, among others, of a process for utilizing the portable radio receiver unit of FIG. 1.

FIG. 7 is a sample channel chart utilized in the process of FIG. 6.

FIGS. 8A-8B are diagrams representing one embodiment, among others, of the portable radio receiver unit of the present disclosure.

FIGS. 9A-9B are block diagram representations of electronic components utilized in implementing one embodiment, among others, of an electronics package for the portable radio receiver unit of FIGS. 8A-8B.

FIG. 10 is a flowchart describing one embodiment, among others, of a process for receiving radio communications according to the present disclosure.

### DETAILED DESCRIPTION

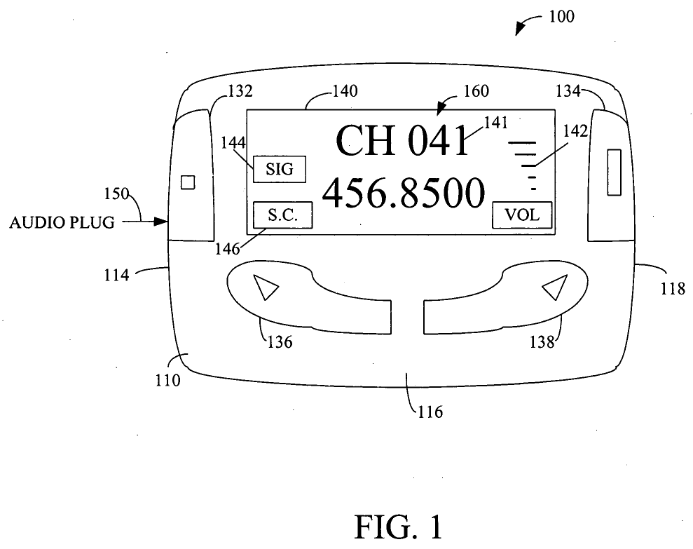

One embodiment of a portable radio receiver unit of the present disclosure is illustrated in FIG. 1. The portable radio receiver unit 10 shown in FIG. 1 is a relatively small, compact radio scanner with basic essential features.

Generally described, the portable radio receiver unit 100 comprises a housing 110 including a user interface console. As described in more detail below, the portable radio receiver unit 100 consists of (includes only) the housing 110, a device connected to the housing for receiving radio communications on radio channels, and a system connected to the housing for tuning or selecting a preprogrammed radio channel in response to an operator command. Typically, the electronically stored radio channels correspond to radio frequencies and are stored in dedicated memory locations.

The housing 110, in one embodiment, is made of injection-molded plastic and has a length extending along a longitudinal axis from a left end 114 to a right end 118. The housing 110 includes a display screen 140 across the central portion 116 of the housing 110. The housing also includes a user interface console around the display screen 140. The user interface console includes a left side button 132, a right side button 134, a left scroll button 136, and a right scroll button 138. At the right end 118, an audio port 150 is located. An earpiece or headphone device (or other audio speaker device) may be plugged into the audio port 150 so that a user can hear radio communications received from the portable radio receiver unit 100.

The display screen 140 is capable of indicating a radio channel 141 that has been selected by a user, along with other setting indications such as volume status 142, signal status 144, squelch control status 146, as is described further below.

There are two modes of operation for the portable radio receiver unit 100: Normal Mode for listening and basic operations; and Channel Change Mode used for changing the desired channel or frequency. The four buttons 132-138 on the portable radio receiver unit 100 have different functions depending on the mode.

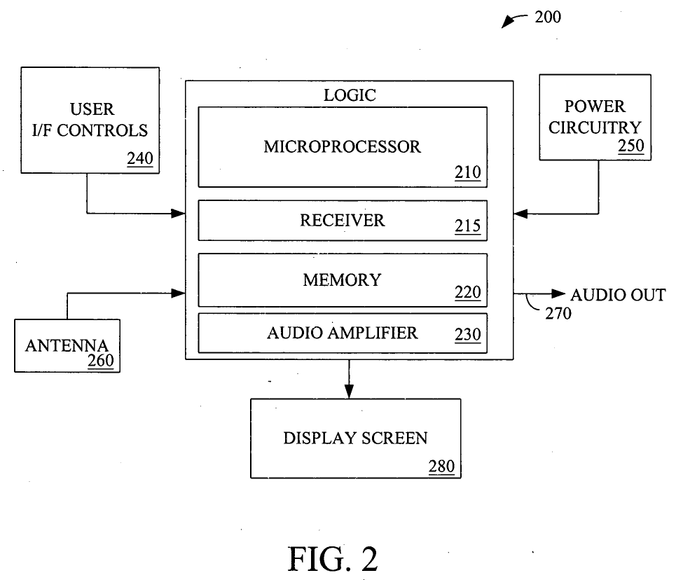

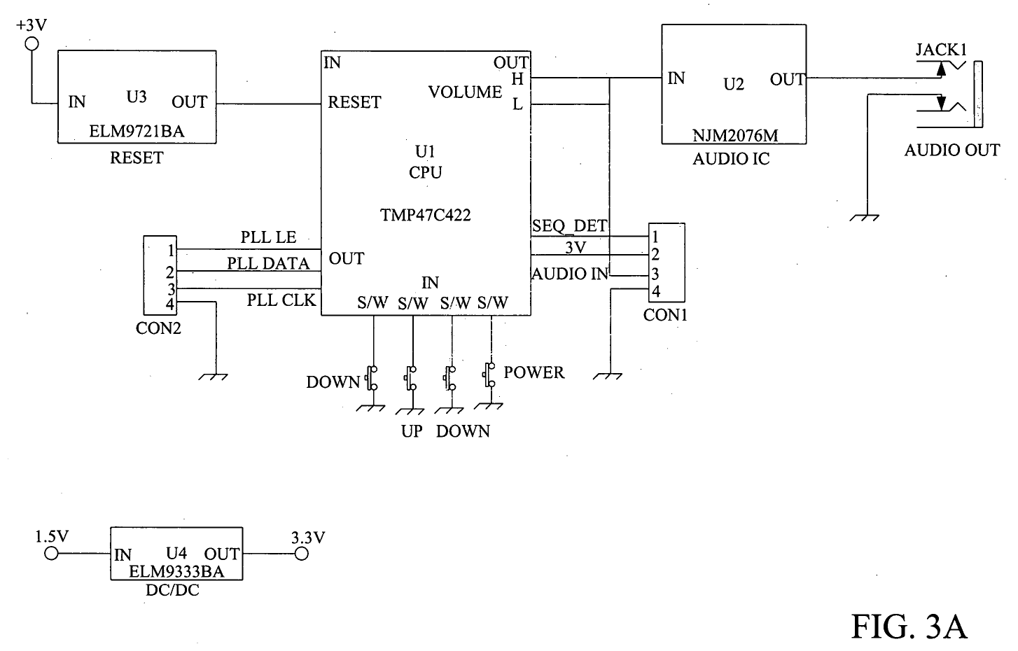

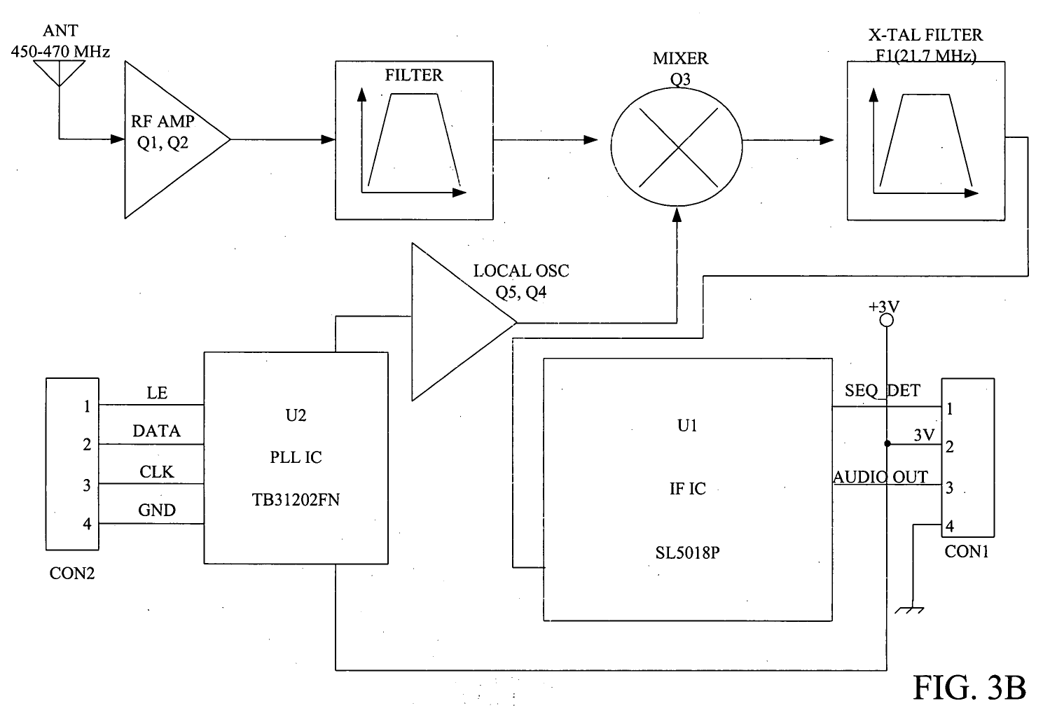

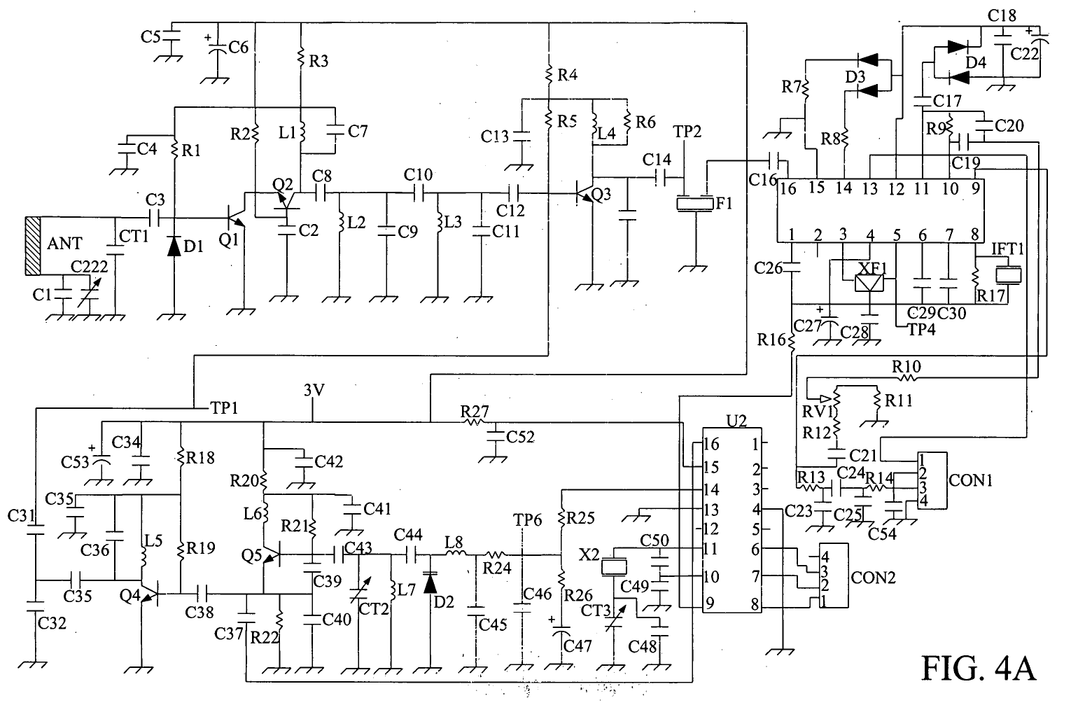

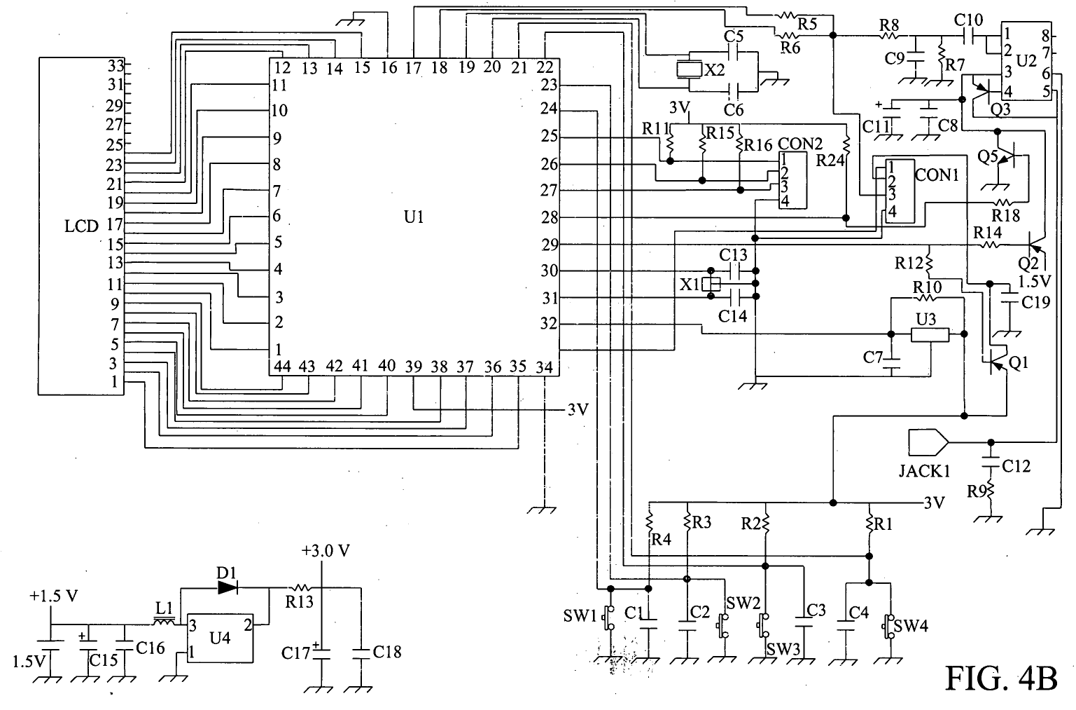

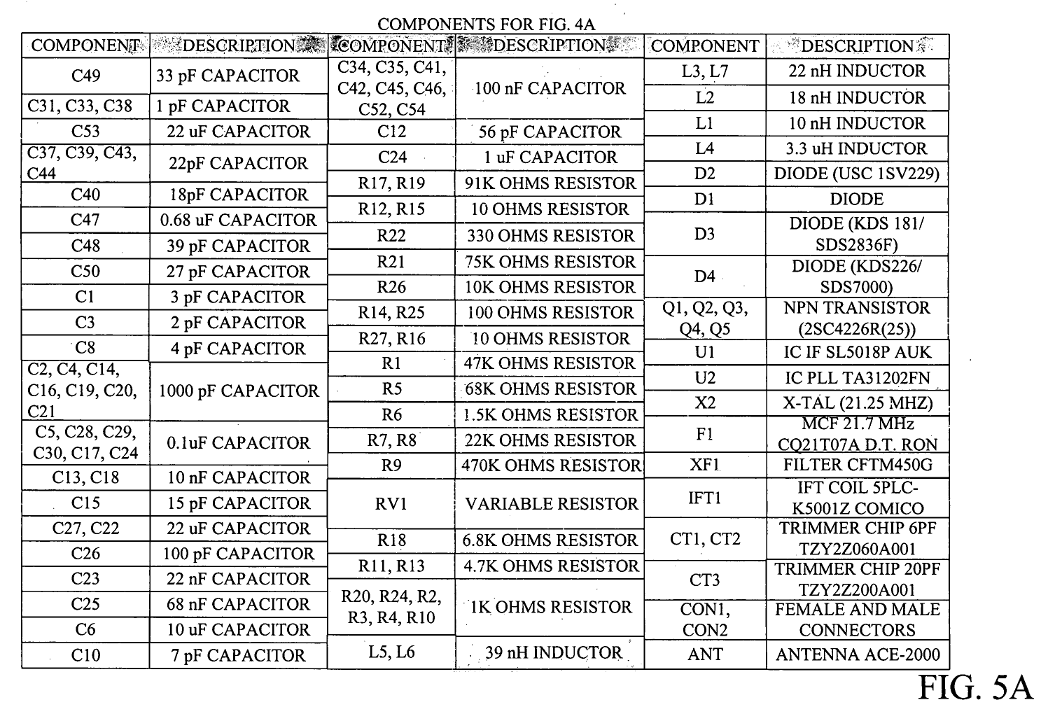

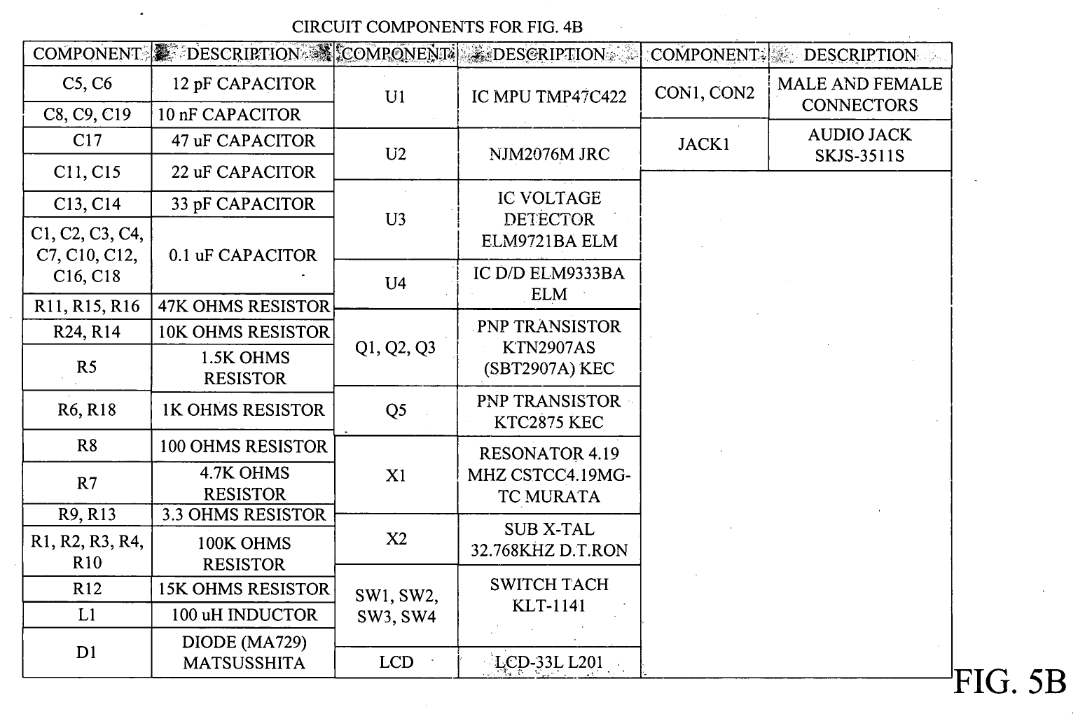

In one embodiment, the electronic components of radio receiver unit 100 are conventional and a suitable electronics package is illustrated in FIG. 2. This electronics package 200 generally comprises device logic 205 which further includes microprocessor 210, receiver logic 215, memory logic 220, and audio amplifier logic 230. Inputs to the device logic 205 includes user interface controls 240, power circuitry 250, and antenna circuitry 260. Outputs from the device logic 205 include audio output signals 270 and display screen 280. One implementation of the electronic package is shown in FIGS. 3A and 3B. A more detailed representation of this electronic package is also shown in FIGS. 4A and 4B. Correspondingly, component descriptions for select elements shown in FIGS. 3A-3B and 4A-4B are provided in tables displayed in FIGS. 5A and 5B. It should be understood that the components of the electronic package 200 used in the portable radio receiver unit 100 may vary in other embodiments.

Referring now to FIGS. 1 and 2, the portable radio receiver unit's buttons 132-138, when pressed, send a signal to a microprocessor 210. The microprocessor 210 enables the user to select a channel for listening and the portable radio receiver unit 100 is tuned to the selected channel. The microprocessor 210 is coupled to an LCD (light crystal display) display screen 140, 280 for displaying the selected channel.

The microprocessor 210 controls the basic functions of the portable radio receiver unit 100, in response to pressing of the buttons 132-138, such as providing power up or power down, controlling volume level, and other functions as further described below. For example, the portable radio receiver unit 100 may be turned turn on by pressing a button 132 on the left side of the unit for a set time period (e.g., one second). Correspondingly, by pressing and holding the button 132 (left side) for another set time period, such as five seconds (until the display 140 shuts off), the portable radio receiver unit 100 may be turned off.

The portable radio receiver unit 100, in one embodiment, is preprogrammed with a multitude of radio channels (e.g., 1600 pre-programmed channels) that can be selected by a user, and each channel is associated with a different radio frequency (e.g., from 450-470 MHz). Note, virtually all drivers today in organized motor sports racing (e.g., NASCAR®, Busch, Indy®, Trucks, Petite LeMans®, etc.) use frequencies between 450 to 470 MHz and the radio receiver 100 unit is capable of handling all of them. Therefore, once a user knows the channel number of a particular driver, team, or radio broadcast he or she desires to monitor, the need to remember or enter a 7-digit frequency is eliminated.

The portable radio receiver unit 100 can be used to receive radio transmissions within a given range. For example, one embodiment receives transmissions on any of the 1600 licensed frequencies in the UHF band between 450 MHz and 470 MHz for a distance up to 2 miles (line of sight). While conventional radio scanners are often encumbered by an exterior antenna for reception, some embodiments of the portable radio receiving unit 100 utilize an internal antenna, completely invisible to the user. This is a tremendous advantage with regard to ease of transportation, storage, and convenient use.

In one embodiment, to put the portable radio receiver unit 100 in Channel Change Mode, a user may press the button 134 on the right side for two seconds, until the channel display 160 starts blinking. Then, the user can use the left side button 132 to move up in 100 channel increments, until the user is near a desired frequency, as indicated by the display screen 140. After which, the user can use the lower scroll buttons 136, 138 to scroll to a desired channel, and then press the right side button 134 again to lock the channel. When locked on a channel, the visual display stops blinking on the display screen 140.

All frequencies are permanently programmed in the portable radio receiving unit 100 and are every 12.5 Hz. apart, at the standard spacing as currently licensed by the Federal Communications Commission. Thus, the portable radio receiving unit 100 is preprogrammed to enable reception on all licensed frequencies in a given range. The user simply directs the device to receive on a specific frequency by using convenient interface controls. This efficiently completely eliminates the need, inconvenience, and expense or reprogramming by a computer, or professional, or technician.

The portable radio receiver unit 100 is also programmed to allow a user to easily “jump” between a selected channel and a default channel. After locking in a chosen channel, a user may simply press both scroll buttons 136, 138 simultaneously to jump to the default channel, and then, press both scroll buttons 136, 138 again to jump back to the locked channel. Typically, embodiments of the portable radio receiving unit 100 store the radio frequency used for hosting the general radio broadcast (e.g., Motor Racing Network (MRN) broadcast or Performance Racing Network (PRN) broadcasts) for most motor sports events.

The portable radio receiver unit 100 also has a signal indicator 144 in the upper left of the display screen 140 that appears when a signal is being received by the portable radio receiver unit 100 and disappears when the signal stops. This feature is automatic and no interaction is required. The default functionality of the two lower scroll buttons 136, 138 is volume control. To increase the volume level, a user presses the right lower button 138. Correspondingly, to decrease the volume level, the user presses the left lower button 136. A volume level indicator 142 is also displayed on the display screen 140. Some embodiments may also include an in-line volume control on an ear-set that is plugged into the portable radio receiver unit 100 via the audio port 150. For optimal clarity, the full volume in the portable radio receiver unit 100 may be backed offed a notch or two, and then, the in-line control may be used for adjusting the volume to fit the user's needs.

To reduce background noise and static, an internal squelch filter control is typically provided with the portable radio receiving unit 100. Generally, a squelch filter control is a control that keeps audio output muted (quiet and free from static) when there is no transmission being received on a channel. Since under most circumstances, a user will probably want the squelch control on, the default setting for the portable radio receiver unit 100 is to turn the squelch filter control on. However, to turn the squelch filter control off, a user simply presses the right side button 134 and the left scroll button 136 at the same time, and a squelch indicator (SQ) 146 then disappears from the display screen 140 to show that the squelch filter control has been deactivated. To turn the squelch filter control back on, the user presses the right side button 134 and the right scroll button 138 at the same time. The squelch indicator 146 then appears on the display screen 140.

The portable radio receiver unit 100 delivers hours of continuous usage on a single battery via the power circuitry 250. For example, the power circuitry 250 maybe configured to operate with a high quality AAA alkaline battery. Thus, a user can utilize the compact radio receiver unit 100 for an entire motor sports race, for example, in lieu of carrying a bulky radio scanner that also may need programming or charging. As such, the portable radio receiver unit 100 may be easily placed in a user's pocket or even clipped to a user's belt or worn around the user's neck.

In addition to the many uses an event spectator may employ with the portable radio receiver unit 100, the portable radio receiver unit is also very useful for other event participants, such as race car drivers. For example, many forms of automobile racing do not have suitable technology for in-car listening “listen only” race communications with track and race control. However, with the small and convenient size of the portable radio receiver unit 100 combined with superior performance, the portable radio receiver unit 100 is now used in many racing leagues, as well as a growing number of short tracks around the country, since the portable radio receiver unit 100 can easily fit in a driver's pocket and allows for a lot of time to be saved during races in getting the field lined up before a race and during a caution period. It also helps increase the safety level for both the drivers and on-track series officials. Previously, without the portable radio receiver unit communication, the race director had to radio the information to an official on the track, who wrote the line-up on a chalkboard, and then showed it to the drivers when they rolled down the front straightaway. Now, with the portable radio receiver unit communication, a driver can be informed if something is wrong with his or her race car, or it has a flat tire, and needs to go to the pit area.

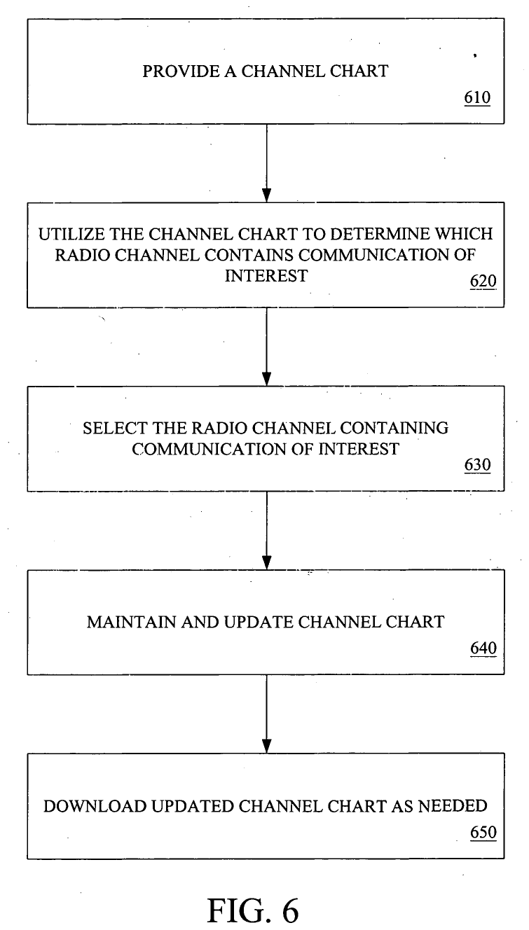

Referring now to FIG. 6, a flowchart describing one embodiment, among others, of a process for utilizing the portable radio receiver unit 100 is shown. In this process, a channel chart is provided (610) for a user of the portable radio receiver unit 100, as shown in FIG. 6. For example, a channel chart for a particular sporting event may be provided on a web site that can be accessed and printed by the user. The channel chart contains the channels programmed on the portable radio receiver unit along with the associated radio frequencies and further identification information. For example, for a particular motor sports event, identification of a driver employing the radio channel/frequency is provided on the channel chart for the particular motor sports event, in some embodiments. Therefore, a fan of a particular driver can locate the driver's name and then use the identification information to ascertain the radio channel on which the driver (and his or her crew) is communicating. Accordingly, by utilizing (620) the channel chart, a user is able to determine which radio channel contains communications of potential interest. Then, the user selects (630) the radio channel to receive communications on this radio channel listed on the channel chart.

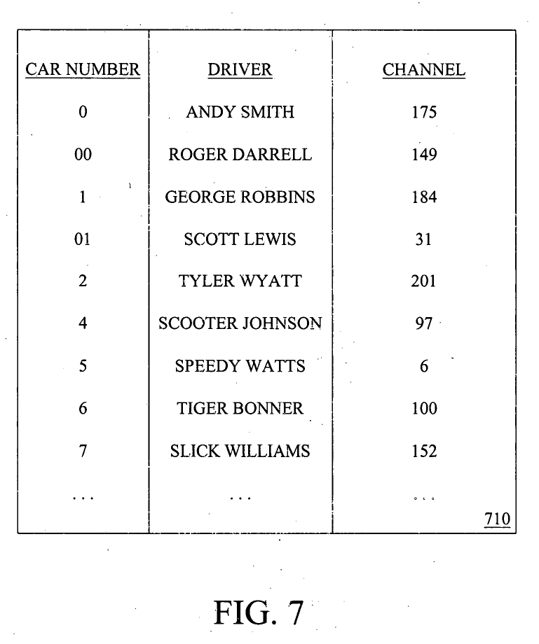

Note, most frequencies assigned to racing teams fall within a certain band on the UHF spectrum. Further, most drivers or teams have a primary channel, and several alternates in case they have interference or a conflict on the primary frequency. Thus, one embodiment, among others, of the portable radio receiver unit 100 comes preprogrammed with most of these channels. To accommodate changes that occur, such as a driver switching to another radio frequency or channel, the channel chart is maintained and updated (640) to remain current. Accordingly, a user can retrieve (650) (e.g., download) an updated channel chart, at any time, the user needs one. A sample channel chart 710 is shown in FIG. 7.

Typically, the portable radio receiver unit 100 is designed to receive signal anywhere in a typical sporting venue or track. For example, some embodiments of the portable radio receiver unit 100 have a reception range of 1-2 miles in a standard setting, and well over that range in some set ups. Reception can depend on many factors, like the strength of transmission, line of sight obstructions, etc.

Advantageously, some embodiments of the portable radio receiver unit 100 are further designed to receive transmissions on a given frequency of the user's choice and to allow simple changing of the chosen frequency without the need for reprogramming. The portable radio receiver unit is 90% smaller in size and weight, compared to the average conventional use for the same purpose. The footprint of one embodiment of the portable radio receiver unit 100, among others, is about ⅔rds the size of a standard business card, measuring only 0.625″×1.75″×2.5″. Further, one embodiment of the portable radio receiver unit 100, including the required battery power, is negligible at only 1.6 ounces (including required battery) without the ear-set and only 2.2 ounces with the ear-set. The insignificant weight of the unit allows the user to wear the unit like a wristwatch using an optional wrist strap, or clip the unit to a pocket, jacket, belt, or hat, without any inconveniences using a supplied “holster” with clip. This very small design also allows the user to avoid the use of cumbersome accessory bag when transporting the unit and dramatically reduces the complexity of security searches upon entrance into a venue.

Advantageously, the portable radio receiver unit 100 is also dramatically more efficient than conventional radio scanners with regard to power consumption. Unlike conventional radio scanners, the portable radio receiver unit 100 is dramatically more power efficient and will operate for one entire sporting event, 4-6 hours, even up to 8-10 hours, on a single AAA Alkaline battery. This allows the user to avoid the inconvenience of recharging a “rechargeable” battery pack, as found in many examples of conventional models, or expense of operation using 4 AA batteries.

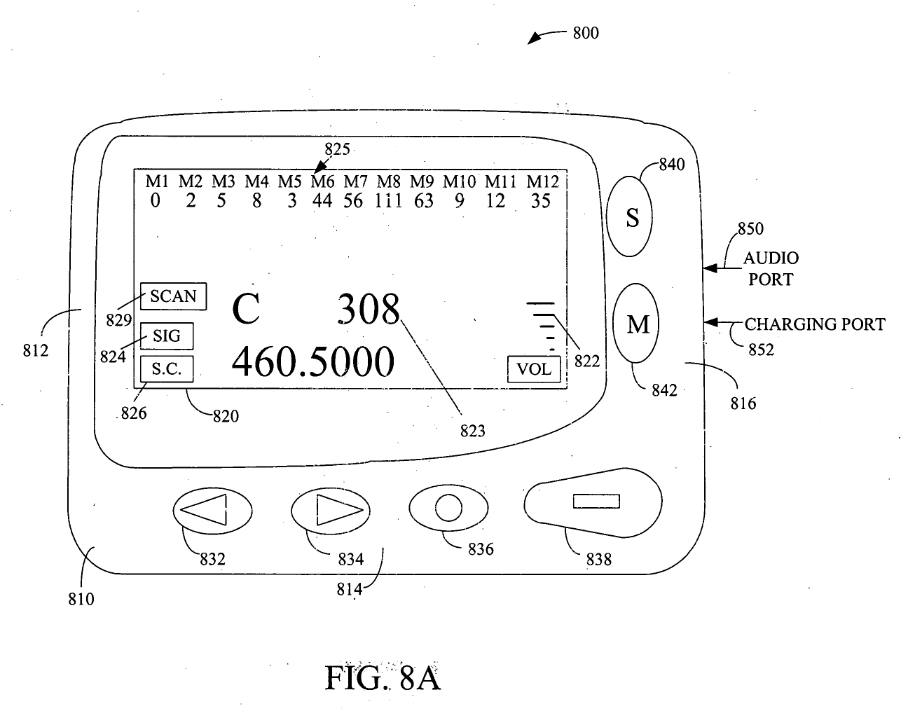

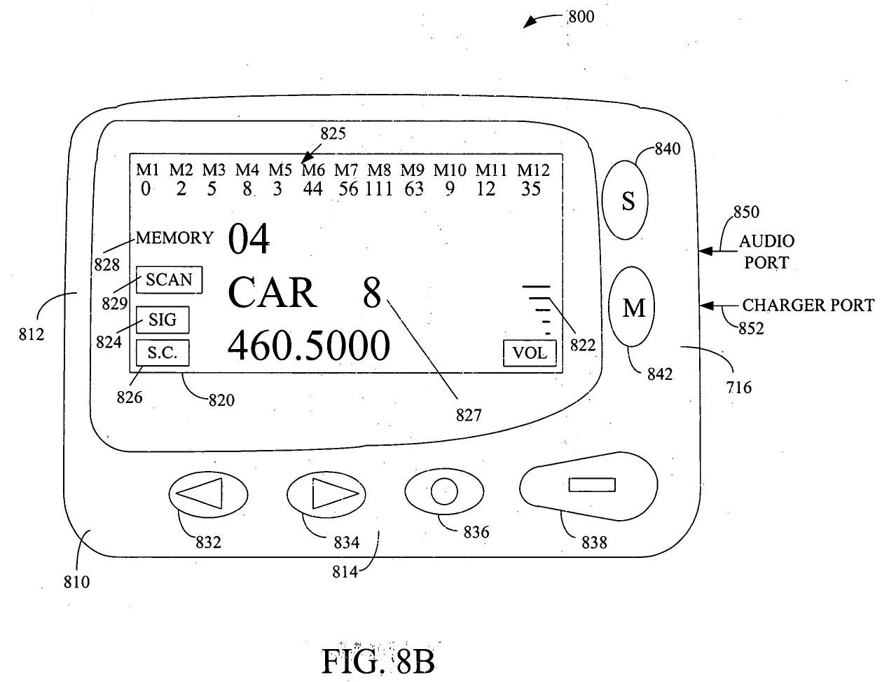

Next, another embodiment of a portable radio receiver unit of the present disclosure is illustrated in FIGS. 8A-8B. The portable radio receiver unit 800 shown in FIGS. 8A-8B is a relatively small, compact radio scanner with more features than the embodiment discussed with regard to FIG. 1, yet still advantageously more portable than conventional radio scanners.

Generally described, one embodiment of the portable radio receiver unit 800 comprises a housing 810 including a user interface console. As described in more detail below, the portable radio receiver unit 800 consists of (includes only) the housing 810, a device connected to the housing for receiving radio communications on radio channels, and a system connected to the housing for tuning or selecting a radio channel in response to an operator command. Typically, the electronically stored radio channels correspond to radio frequencies and are stored in dedicated memory locations.

The housing 810, in one embodiment, is made of injection-molded plastic and has a length extending along a longitudinal axis from a left end 812 to a right end 816. The housing 810 includes a display screen 820 across the central portion 814 of the housing 810. The housing 810 also includes a user interface console around the display screen 820. The user interface console includes a first button 832, a second button 834, a third button 836, and a fourth button 838 located underneath the display screen 820. At the right end, a fifth button 840 and a sixth button 842 are located. An earpiece or headphone device (or other audio speaker device) may be plugged into the audio port 850 so that a user can hear radio communications received from the portable radio receiver unit 800.

The display screen 820 is capable of indicating that a radio channel has been selected by a user, along with other setting indications such as volume status 822, signal status 824, squelch control status 826, etc. as is described further below.

In one embodiment, the electronic components of radio receiver unit 800 are conventional, and the electronics package illustrated in FIG. 2 is representative of an electronics package that may be utilized with radio receiver unit 800. As previously discussed, this electronics package 200 generally comprises device logic 205 which further includes microprocessor 210, receiver logic 215, memory logic 220, and audio amplifier logic 230. Inputs to the device logic 205 include user interface controls 240, power circuitry 250, and antenna circuitry 260. Outputs from the device logic 205 include audio output signals 270 and display screen 280.

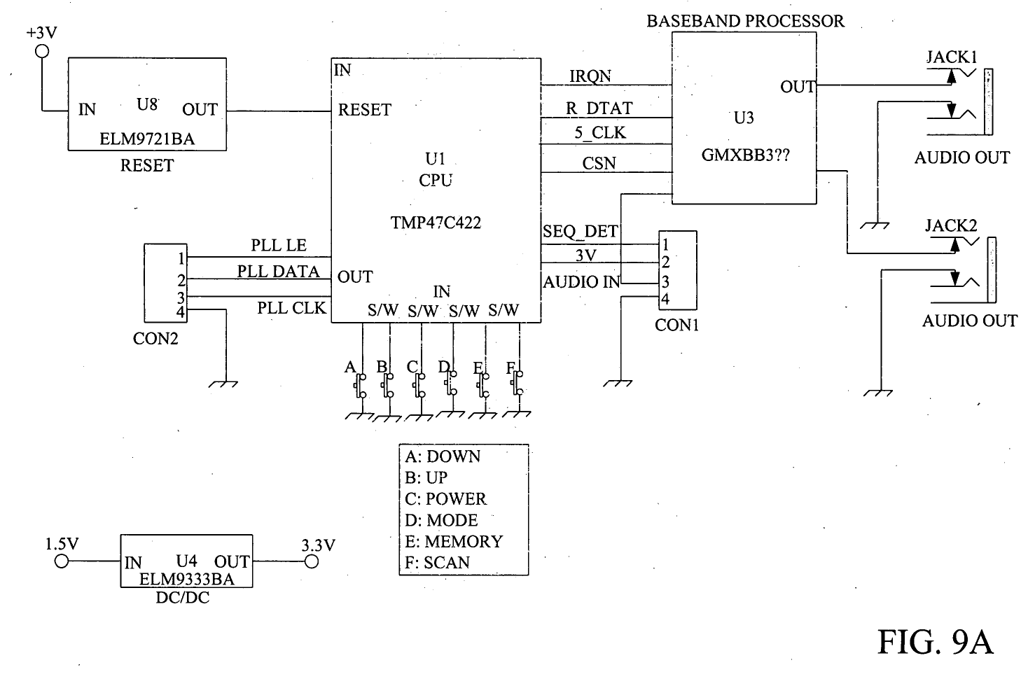

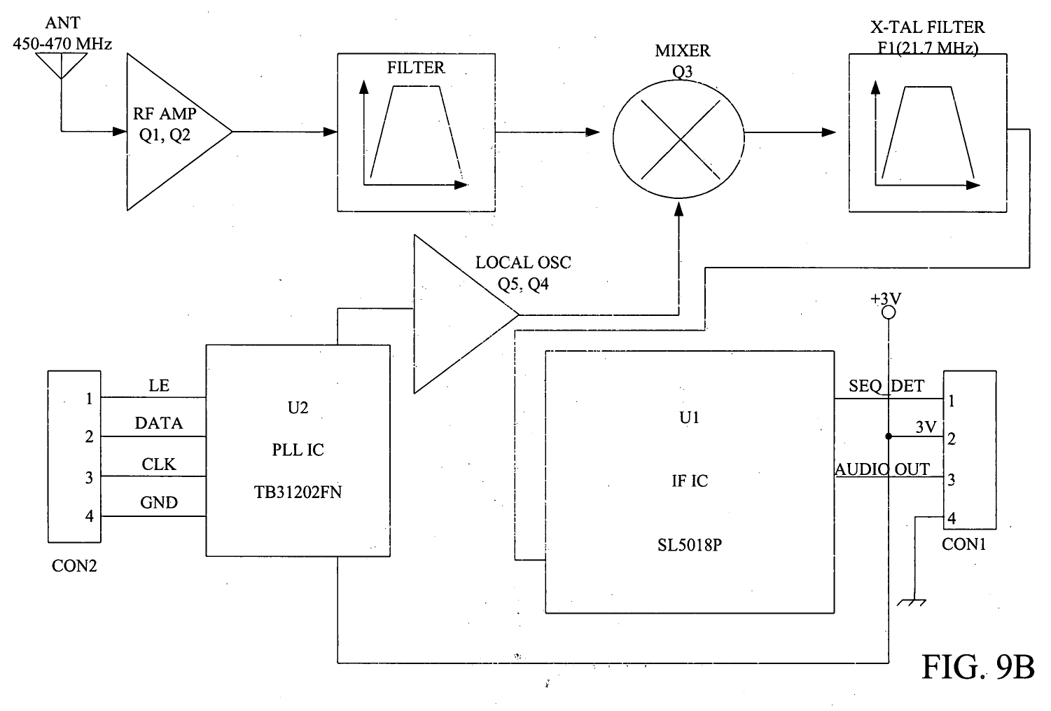

The portable radio receiver unit's buttons 830-842, when pressed, send a signal to a microprocessor 210. The microprocessor 210 enables the user to select a channel for listening and the portable radio receiver unit 800 is tuned to the selected channel. The microprocessor 210 is coupled to an LCD display screen 820 for displaying the selected channel. The microprocessor 210 controls the basic functions of the portable radio receiver unit 800, such as providing power up or power down, controlling volume level, and other functions as further described below. It should be understood that the components of the electronic package used in the portable radio receiver unit 800 may vary in other embodiments. One implementation of the electronic package is shown in FIGS. 9A and 9B.

The portable radio receiver unit 800 is preprogrammed with a multitude of radio channels (e.g., 1600 pre-programmed channels) that can be selected by a user and each channel is associated with a different radio frequency (e.g., from 450-470 MHz, where channel 1 may be associated with 450.0000 MHz frequency). The portable radio receiver unit 800 has several display icons which include current memory view 828; scan indicator 829; squelch control 826; low battery indicator (not shown); volume indicator 822; car number indicator 827; signal indicator 824; and car memory locations indicators 825. In particular, the current memory view 828 indicator shows the current memory location being accessed via an enlarged memory icon. The scan indicator 829 displays when scanning memory locations. The squelch control indicator 826 is displayed when the squelch filter has been activated which is typically set to be activated on startup. The low battery indicator (not shown) displays when the battery needs to be replaced. The volume indicator 822 shows the volume level for the portable radio receiver unit. The car number indicator 825 displays the car number assigned to the stored frequency. As such, the portable radio receiver unit 800 is capable of storing multiple frequencies by car number.

In FIGS. 8A-8B, the embodiment of the portable radio receiver unit 800 features 6 button operation. For example, by pressing the channel up button 834 (“second button”), the volume level is increased. By pressing the channel down button 832 (“first button”), the volume level is decreased. Pressing the scan button 840 (“fifth button”) causes the memory locations to be scanned. Pressing the mode button 842 (“sixth button”) causes the current mode to change. To access different channels, the right selection button 838 (“fourth button”) is pressed and held. To power on or off the portable radio receiver unit, the left selection button 836 (“third button”) is pressed for a set time period (e.g., five seconds). To access a light for illuminating the display, the left selection button 836 is pressed and held for another set time period, such as two seconds. Advantages of the portable radio receiver unit 800 include being small and lightweight with an internal amplified antenna; having a back light for night operations; operating on one AA battery for up to 18 hours while scanning; being NiCad and NiMH capable with a charging port 852; and having a dual 3.5 audio port 850, as previously mentioned.

There are three modes of operation for the portable radio receiver unit 800: Regular Mode for listening and basic operations; Memory Mode for listening to stored channels in one or more memory locations; and Program Memory Mode for programming one or more memory locations to store a particular radio channel and associated information. The six buttons 832-842 on the portable radio receiver unit 800 have different functions depending on the mode.

In Regular Mode, as shown in FIG. 8A, the portable radio receiver unit 800 allows a user to listen to one channel or frequency. A user can activate the Regular Mode, by pressing and holding the right selection button 838 for a set time period (e.g., two seconds) until the channel display indicator 823 is blinking. Then the left selection button 836 can be pressed to scroll or advance through the channels, 100 channels at a time. Also, the channel up button 834 can be pressed to scroll up channels, one channel at a time. Accordingly, the channel down button 832 can be pressed to scroll down channels one channel at a time. Once a desired channel has been selected, the right selection button 838 can be pressed to lock the portable radio receiver unit 800 on the channel. In addition, the portable radio receiver unit 800 can “jump” to a default channel, e.g., a channel stored in a first memory location (“M1”), by pressing both the channel up button 834 and the channel down button 832 at the same time. Accordingly, a user can toggle between a locked channel and the default channel by repeatedly pressing, at the same time, the channel up button 834 and the channel down button 832.

In Memory Mode, as shown in FIG. 8B, the portable radio receiver unit 800 can scan memory locations M2 to M12. Further, the user can scroll all memory locations and jump to memory location M1 and back. To activate the Memory Mode, the user presses the memory button 842. Then, the user can scroll up memory locations by pressing the right selection button 838 and can scroll down memory locations by pressing the left selection button 836. To toggle between scanning and not scanning the memory locations 825, the user can press the scan button 840. Further, simultaneously pressing the channel up button 834 and the channel down button 832 allows the user to jump between a selected channel and the channel stored in memory location M1.

In Program Memory Mode, a user can program channels or frequencies into memory locations 825. Note, in some embodiments, memory location M1 is designed for a broadcast location and is not available for scanning. Further, in some embodiments, M2 is a priority memory location and is scanned more often than other memory locations. Thus, the portable radio receiver unit 800 can perform 11 channel auto scanning with 1 priority channel that is checked more often than the other channels, in some embodiments.

To program memory locations, in some embodiments, a user first presses the memory button 842 to activate the Regular Mode. Then by pressing and holding the right selection button 838, the channel display indicator 823 starts blinking. The user can then press the left selection button 836, the channel up button 834, and/or the channel down button 832 to select a desired channel for storing. As previously discussed, the left selection button 836 is used to scroll through channels, a hundred channels at a time. The channel up button 834 is used to scroll up channels, one channel at a time, and the channel down button 832 is used to scroll down channels, one channel at a time. Further, the user can press and hold the memory button 842 until the display changes to “CAR” 827. After which, the user can use the channel up button 834 and the channel down button 832 to select a desired car number to associate with the selected radio channel (frequency). After a car number is entered, the user presses and holds the memory button 842 until the memory location indicator 828 starts to blink. Then, the user presses the right selection button 838 once to complete programming and to return the portable radio receiver unit 800 to Regular Mode operation. In this manner, up to 11 radio frequencies may be stored in memory locations according to car numbers employing the respective radio frequencies, for some embodiments, in some embodiments.

To delete a radio channel stored in an individual memory location, in some embodiments, the mode button 842 is pressed and then the right selection button 838 is pressed to scroll up memory locations or the left selection button 836 is pressed to scroll down memory locations. After the desired memory location is located and selected, the scan button 840 and the channel down button 832 are simultaneously pressed for a set time period (e.g., two seconds) to delete the contents of the selected memory location. Alternatively, in some embodiments, contents of all the memory locations can be deleted by removing the battery for 10 seconds or longer and then reinserting the battery while pressing the channel down button 832 for a set time period (e.g., 5 seconds). As a result, all previously saved memory locations are deleted.

This embodiment of the portable radio receiver unit runs on a single AA battery for an entire race and is small enough to be worn around a user's neck; dropped in a user's pocket; or placed in a belt clip holster. With a dual 3.5 mm audio port and weighing 3.5 ounces, some embodiments operate up to 14 hours while scanning on 1 AA battery. Advantageously, the portable radio receiver unit 800 changes the way fans listen to racing or enjoy spectator events, in general.

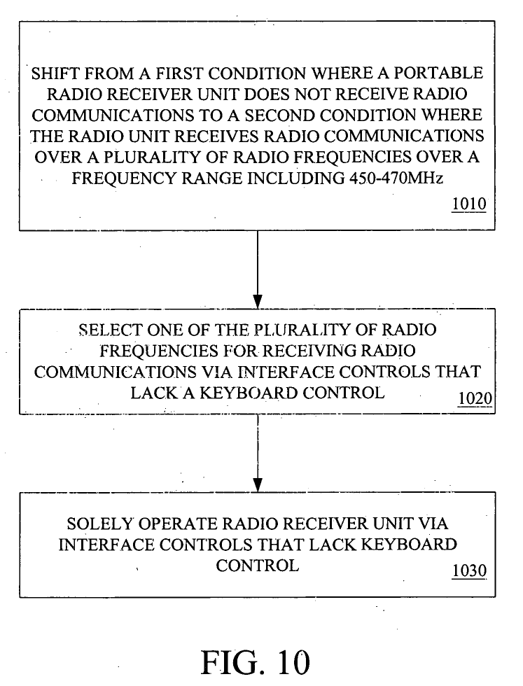

Next, FIG. 10 is a flowchart describing one embodiment, among others, of a method for receiving radio communications. First, a portable radio receiver unit shifts (1010) from a first condition where the portable radio receiver unit does not receive radio communications to a second condition wherein the portable radio receiver unit receives radio communications over a plurality of radio frequencies over a frequency range including 450-470 MHz. Then, by selecting (1020) one of the plurality of radio frequencies for receiving radio communications via the portable radio receiver unit, operation of the portable radio receiver unit is solely controlled (1030) by interface controls that lack a keyboard control. In the embodiment associated with FIG. 1, the interface controls consist of 4 interface controls. Further, in the embodiment associated with FIGS. 8A-8B, the interface controls consist of 6 interface controls.

Embodiments of the present disclosure can be implemented in hardware, software, firmware, or a combination thereof. If implemented in hardware, the portable radio receiver unit can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

It should be emphasized that the above-described embodiments of the present disclosure are merely possible examples of implementations, merely set forth for a clear understanding of the principles of embodiments of the disclosure. Many variations and modifications may be made to the above-described embodiments of the disclosure without departing substantially from the spirit and principles of the disclosure. For example, the functions noted in the blocks of flowcharts, previously presented, may occur out of the order noted in accompany figures. For example, two blocks shown in succession may in fact be executed substantially concurrently or the blocks may sometimes be executed in the reverse order, depending upon the functionality involved. All such modifications and variations are intended to be included herein within the scope of this disclosure and protected by the following claims.

1. A portable radio receiver unit, comprising:
a housing having interface controls;
means connected to the housing for receiving radio communications by radio transmissions over radio frequencies, the portable radio receiver unit capable of receiving radio communications over a frequency range including 450-470 MHz, wherein operation of the portable radio receiver unit is controlled solely by operation of four interface controls disposed in the housing.

2. The portable radio receiver unit of claim 2, the four interface controls including:
first means disposed in the housing for selectively producing a first condition in the portable radio receiver unit and alternatively, producing a second condition in the portable radio receiver unit, the first condition being a state wherein the portable radio receiver unit does not receive radio communications by radio transmissions over radio frequencies and the second condition being a state wherein the portable radio receiver unit receives radio communications by radio transmissions over radio frequencies; and
second means disposed in the housing for selecting a radio fiequency for receiving radio communications on the portable radio receiver unit.

3. The portable radio receiver unit of claim 1, wherein the width of the portable radio receiver unit is less than 2 inches and the length of the portable radio receiver unit is less than 3 inches.

4. The portable radio receiver unit of claim 1, wherein the width of the portable radio receiver unit is less than 1.75 inches and the length of the portable radio receiver unit is less than 2.5 inches.

5. The portable radio receiver unit of claim 1, wherein the interface controls do not include a keypad.

6. The portable radio receiver unit of claim 1, wherein the portable radio receiver unit is configured with a plurality of radio frequencies stored in memory.

7. The portable radio receiver unit of claim 6, wherein the four interface controls control the following operations:
turning on the portable radio receiver unit;
turning off the portable radio receiver unit;
adjusting volume level of the portable radio receiver unit;
activating squelch control of the portable radio receiver unit;
selecting a radio frequency to be received by the portable radio receiver unit; and
switching between two radio frequencies that are being received by the portable radio receiver unit.

8. A portable radio receiver unit, comprising:
a housing having interface controls;
means connected to the housing for receiving radio communications by radio transmissions over radio frequencies, the portable radio receiver unit capable of receiving radio communications over a frequency range including 450-470 MHz and automatically scanning for radio communications over a subset of frequencies in the frequency range, wherein operation of the portable radio receiver unit is controlled solely by operation of six interface controls disposed in the housing.

9. The portable radio receiver unit of claim 8, the six interface controls including:
first means disposed in the housing for selectively producing a first condition in the portable radio receiver unit and alternatively, producing a second condition in the portable radio receiver unit, the first condition being a state wherein the portable radio receiver unit does not receive radio communications by radio transmissions over radio frequencies and the second condition being a state wherein the portable radio receiver unit receives radio communications by radio transmissions over radio frequencies; and
second means disposed in the housing for selecting a radio frequency for receiving radio communications on the portable radio receiver unit.

10. The portable radio receiver unit of claim 1, wherein the width of the portable radio receiver unit is less than 2.5 inches and the length of the portable radio receiver unit is less than 3.25 inches.

11. The portable radio receiver unit of claim 1, wherein the width of the portable radio receiver unit is less than 3 inches and the length of the portable radio receiver unit is less than 3.5 inches.

12. The portable radio receiver unit of claim 1, wherein the interface controls do not include a keypad.

13. The portable radio receiver unit of claim 1, wherein the portable radio receiver unit is configured with a plurality of radio frequencies stored in memory and a plurality of memory locations for storing designated radio frequencies.

14. The portable radio receiver unit of claim 13, wherein the portable radio receiver unit is further configured to store an identifying label for each radio frequency stored in a memory location.

15. The portable radio receiver unit of claim 14, wherein the identifying label is a car number utilizing the radio frequency for a motor sports event.

16. The portable radio receiver unit of claim 13, wherein the six interface controls control the following operations:
turning on the portable radio receiver unit;
turning off the portable radio receiver unit;
adjusting volume level of the portable radio receiver unit;
activating squelch control of the portable radio receiver unit;
selecting a radio frequency to be received by the portable radio receiver unit;
switching between two radio frequencies that are being received by the portable radio receiver unit;
programming a radio frequency into a designated memory location; and
scanning a plurality of radio frequencies stored in a plurality of memory locations.

17. A method for receiving radio communications, comprising the steps of:
shifting a portable radio receiver unit from a first condition wherein the portable radio receiver unit does not receive radio communications to a second condition wherein the portable radio receiver unit receives radio communications over a plurality of radio frequencies over a frequency range including 450-470 MHz;
selecting one of the plurality of radio frequencies for receiving radio communications via the portable radio receiver unit, wherein operation of the portable radio receiver unit is solely controlled by interface controls that lack a keyboard control.

18. The method of claim 17, wherein the interface controls consist of four individual interface controls.

19. The method of claim 17, further comprising the step of:
storing a designated radio frequency into one of a plurality of memory locations; and
scanning a plurality of radio frequencies stored in the plurality of memory locations for radio communications.

20. The method of claim 19, wherein the interface controls consist of six individual interface controls.
